(19) United States
(12) Patent Application Publication
(10) Pub. No.: US 2025/0192329 A1
(43) Pub. Date: Jun. 12, 2025

(54) BATTERY PACK WITH DEPOPULATED AREA

(71) Applicant: Ford Global Technologies, LLC, Dearborn, MI (US)

(72) Inventors: Deanna Marie Winton Hoffman, Ann Arbor, MI (US); Brock Dunlap, Dearborn, MI (US); Michael E. Reibling, Sterling Heights, MI (US); Daniel Benjamin Kok, Ann Arbor, MI (US)

(21) Appl. No.: 18/637,719

(22) Filed: Apr. 17, 2024

Related U.S. Application Data
(60) Provisional application No. 63/607,888, filed on Dec. 8, 2023.

(51) Int. Cl. H01M 50/289; H01M 50/211; H01M 50/507

(52) U.S. Cl. CPC H01M 50/289; H01M 50/507; H01M 50/211

(57) ABSTRACT

A battery pack assembly includes a cross-member assembly extending along a cross-member axis, and a battery array alongside the cross-member assembly. The battery array has at least one group of battery cells and an depopulated area disposed along a battery array axis. A first group of battery cells can be spaced a distance along the battery array axis from a second group of battery cells to provide the depopulated area. A first group of battery cells can be spaced from an endplate of an array to provide the depopulated area.

### CROSS-REFERENCE TO RELATED APPLICATIONS

This disclosure claims priority to U.S. Provisional Application No. 63/607,888, which was filed on Dec. 8, 2023 and is incorporated herein by reference in its entirety.

### TECHNICAL FIELD

This disclosure relates generally to traction battery packs and, more particularly, to traction battery packs having battery arrays with battery cells omitted from some areas to provide one or more depopulated areas.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

In some aspects, the techniques described herein relate to a battery pack assembly, including: a cross-member assembly extending along a cross-member axis; and a battery array alongside the cross-member assembly, the battery array having at least one group of battery cells and an depopulated area disposed along a battery array axis.

In some aspects, the techniques described herein relate to a battery pack assembly, wherein the at least one group of battery cells includes a first group spaced a distance along the battery array axis from a second group to provide the depopulated area.

In some aspects, the techniques described herein relate to a battery pack assembly, wherein the cross-member assembly includes a busbar spanning from the first group to the second group.

In some aspects, the techniques described herein relate to a battery pack assembly, wherein the busbar is directly connected to a tab terminal of a battery cell in the first group and to a tab terminal of a battery cell in the second group.

In some aspects, the techniques described herein relate to a battery pack assembly, wherein the battery array is a first battery array and the cross-member assembly is a first cross-member assembly, and further including a second battery array and a second cross-member assembly alongside the second cross-member assembly, the second battery array including a plurality of battery cells disposed along a second battery array axis without any depopulated area between the plurality of battery cells of the second battery array.

In some aspects, the techniques described herein relate to a battery pack assembly, wherein the at least one group of battery cells is at least one group of pouch-style battery cells.

In some aspects, the techniques described herein relate to a battery pack assembly, wherein an axial length of the battery array is nominally equal to an axial length of the cross-member assembly.

In some aspects, the techniques described herein relate to a battery pack assembly, wherein the cross-member assembly includes a plurality of busbars, wherein tab terminals of the at least one group of battery cells extend through apertures in the cross-member assembly to connect to at least one of the busbars within the plurality of busbars.

In some aspects, the techniques described herein relate to a battery pack assembly, further including a battery pack component that is not a battery cell disposed within the depopulated area.

In some aspects, the techniques described herein relate to a battery pack assembly, including: a cross-member assembly within a battery pack; a first battery array on a first side of the cross-member assembly, the first battery array having a first number of battery cells; and a second battery array on an opposite, second side of the cross-member assembly, the second battery array having a second number of battery cells that is different than the first number of battery cells.

In some aspects, the techniques described herein relate to a battery pack assembly, wherein the first battery array has a first axial length and the second battery array has a second axial length that is different than the first axial length.

In some aspects, the techniques described herein relate to a battery pack assembly, wherein the cross-member assembly is within a battery pack enclosure.

In some aspects, the techniques described herein relate to a battery pack assembly, wherein the cross-member assembly extends in a cross-vehicle direction.

In some aspects, the techniques described herein relate to a battery pack assembly, wherein the second battery array includes a first group of battery cells and a second group of battery cells that is spaced from the first group of battery cells to provide an depopulated area.

In some aspects, the techniques described herein relate to a battery pack battery cell positioning method, including: placing a first battery array within an enclosure, the first battery array having at least one first cross-member assembly spanning between endplates of the first battery array and at least one first group of battery cells between the endplates of the first battery array; and placing a second battery array within the enclosure, the second battery array having at least one second cross-member spanning between endplates of the second battery array at least one second group of battery cells between the endplates of the second battery array, a number of battery cells in the second group of battery cells less than a number of battery cells in the first group of battery cells to provide an depopulated area between the endplates of the second battery array.

In some aspects, the techniques described herein relate to a battery pack battery cell positioning method, wherein the first group of battery cells has a first axial length and the second group of battery cells has a second axial length that is different than the first axial length.

In some aspects, the techniques described herein relate to a battery pack battery cell positioning method, wherein the at least one second group of battery cells includes at least two second groups of battery cells spaced apart from each other to provide the depopulated area.

In some aspects, the techniques described herein relate to a battery pack battery cell positioning method, further including a battery pack component that is not a battery cell disposed within the depopulated area.

In some aspects, the techniques described herein relate to a battery pack battery cell positioning method, wherein a length of the at least one first cross-member is the same as a length of the at least one second cross-member.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack according to an exemplary embodiment of the present disclosure.

FIG. 2 illustrates a perspective and partially expanded view of selected portions of the battery pack of FIG. 1.

FIG. 3 illustrates a perspective view of a battery cells from a battery array in the battery pack of FIG. 2.

FIG. 4 illustrates a schematic top view of the battery pack of FIG. 2.

FIG. 5 illustrates a perspective view of a bracing plate from the battery pack of FIG. 2.

FIG. 6 illustrates a schematic top view of a battery pack according to another exemplary embodiment of the present disclosure.

FIG. 7 illustrates a side view of a portion of an battery array from the battery pack of FIG. 6 with an area of an enclosure removed to show the portion.

### DETAILED DESCRIPTION

This disclosure details a battery pack having battery arrays that include battery cells. At least some of the battery arrays can include one or more depopulated areas where battery cells have been omitted. Omitting battery cells can take place if requirements for the battery pack, such as energy storage or delivery requirements, can be met with fewer battery cells. These and other features are discussed in greater detail in the following paragraphs of this detailed description.

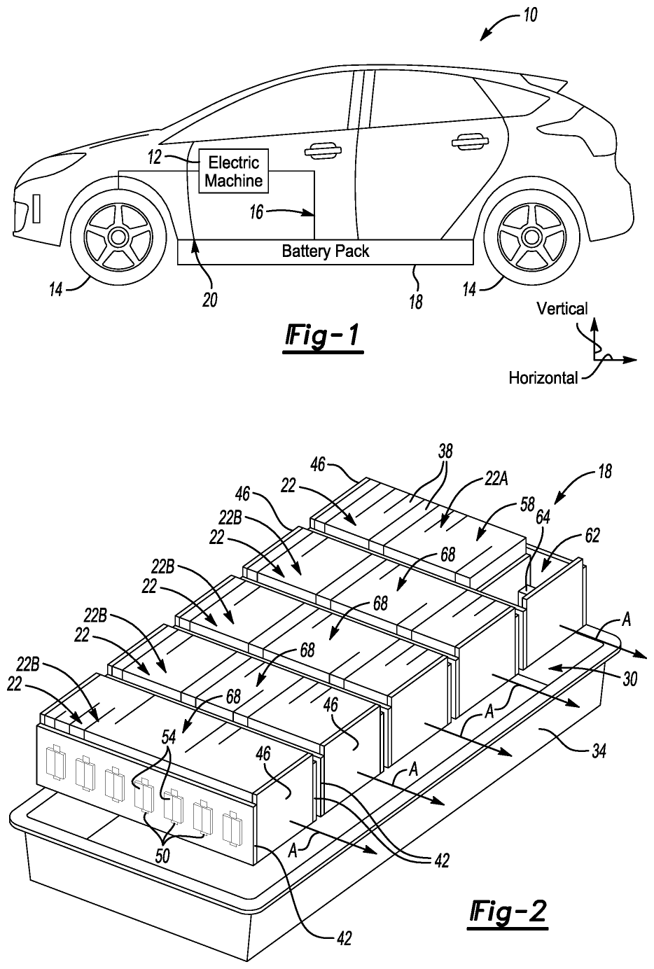

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEVs), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 in other examples.

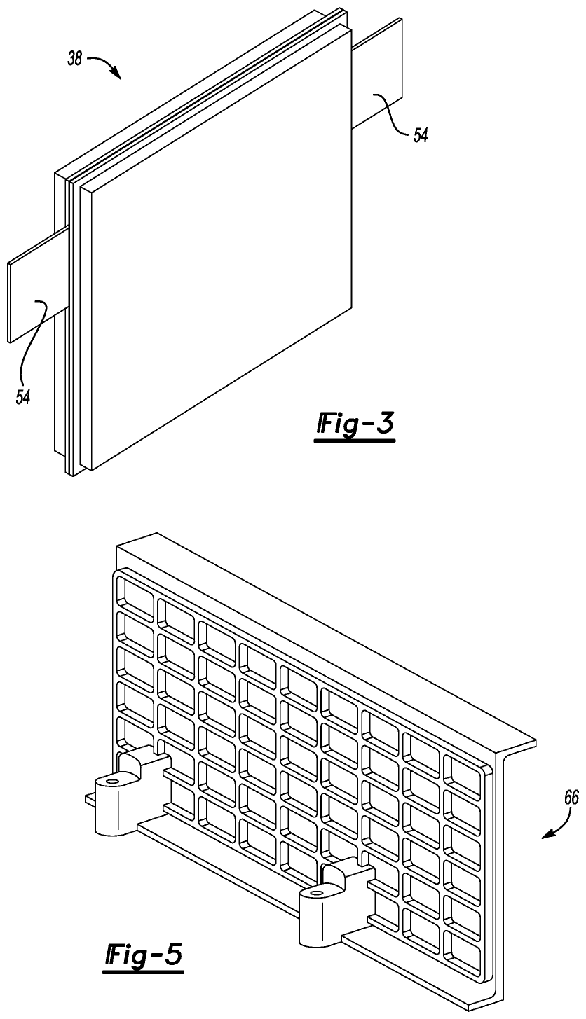

With reference to FIGS. 2-4, the traction battery pack 18 may include a plurality of battery arrays 22 housed within an interior area 30 of an enclosure-here an enclosure tray 34. The enclosure tray 34 can be secured to an enclosure cover, the underbody 20, or both to enclose the battery arrays 22 and other battery internal components within the interior area 30.

Each battery array 22 includes a plurality of battery cells 38 stacked side-by-side relative to one another along a respective array axis A. The battery cells 38 store and supply electrical power for powering various components of the electrified vehicle 10. Although a specific number of the battery arrays 22 are illustrated in the various figures of this disclosure, the traction battery pack 18 could include any number of the battery arrays 22.

The battery arrays 22 additionally each include opposing endplates 46 and a pair of cross-member assemblies 42. The endplates 46 are positioned at opposing axial ends of each of the battery arrays 22. For a given one of the battery arrays 22, the battery cells 38 are positioned between the pair of cross-member assemblies 42 such that the battery cells 38 are alongside the cross-member assemblies 42. In each of the battery arrays 22, the cross-member assemblies 42 extend from the endplate 46 on one end of the battery array 22 to the endplate on the other axial end of the battery array 22.

Among other functions, the cross-member assemblies 42 may be configured to hold the battery cells 38 and at least partially delineate the battery arrays 22 from one another within the interior area 30. The cross-member assemblies 42 also, in this example, include a plurality of busbars 50.

The battery arrays 22 each include at least one group of battery cells 38 disposed along a respective battery array axis A. The at least one group of battery cells 38 can include dividers, thermal interface materials, adhesives, and other materials between the individual battery cells 38.

The cross-member assemblies 42 described herein are configured to increase the structural integrity of the traction battery pack 18. Each of the cross-member assemblies 42 can be configured to transfer a load applied to a side of the electrified vehicle 10. Each of the cross-member assemblies 42, together with the endplates 46, is further configured to accommodate tension loads resulting from expansion and retraction of the battery cells 38.

In an embodiment, the battery arrays 22 and the cross-member assemblies 42 extend longitudinally in a cross-vehicle direction of the electrified vehicle 10. However, other configurations are contemplated within the scope of this disclosure. For example, the cross-members could be oriented to extend longitudinally from the front to the back of the electrified vehicle 10.

In the exemplary embodiment, the battery cells 38 are lithium-ion, pouch-style battery cells. However, battery cells having other geometries (cylindrical, prismatic, etc.) and/or chemistries (nickel-metal hydride, lead-acid, etc.) could alternatively be utilized within the scope of this disclosure. The exemplary battery cells 38 include tab terminals 54 that project outwardly from a battery cell housing. At least some of the tab terminals 54 of each battery array 22 extend through a respective aperture in the cross-member assemblies 42 to electrically connect to each other or to one or more of the busbars 50.

The battery arrays 22 of the battery pack 18 include a battery array 22A and a plurality of battery arrays 22B. The battery array 22A includes a group 58 of the battery cells 38 and an depopulated area 62 disposed along the axis A of the battery array 22A. The depopulated area 62 includes no battery cells 38.

The depopulated area 62 can be left open. The depopulated area 62 can instead be used to house battery pack components 64 other than the battery cells 38. Examples of the battery pack components 64 can include electronics for the battery pack 18, such as a Battery Energy Control Module (BECM). In some examples, particularly if the depopulated area 62 is used to house electronic components, the depopulated area 62 could be at least partially lined with electromagnet shielding material.

The depopulated area 62 can instead or additionally be filled with a filler block. In an example, the filler block could be an injection molded block can be bonded to an enclosure and to the enclosure tray 34 or a thermal exchange plate.

While one depopulated area 62 is shown in this example, the battery array 22A could include more than one depopulated area 62. The other battery arrays 22B could also include one or more depopulated areas.

To maintain alignment and compression of the group 58 of battery cells 38, a bracing plate 66 (FIG. 5) or similar structure can span between the cross-member assemblies 42 of the battery array 22A and can directly attach to the enclosure tray 34. The bracing plate 66 can stabilize the battery cells 38 of the group 58. The bracing plate 66 can be cast aluminum. The bracing plate 66 can include ribs to increase its strength. The bracing plate 66 can be held in position using ribs of the cross-member assemblies 42.

The remaining battery arrays 22B of the traction battery pack 18 each include a group 68 of battery cells 38 along the respective axis A of the battery array 22B without any depopulated area. The group 68 of battery cells 38 fills the area between the endplates 46 of the respective battery array 22B. The number of battery cells 38 in each of the groups 68 is greater than the number of battery cells 38 in the group 58.

Although the battery arrays 22A and 22B are substantially the same length, the battery array 22A has fewer battery cells 38 when compared to the battery arrays 22B due to some of the battery cells 38 being omitted. The capability of the traction battery pack 18 to omit some of the battery cells 38 from areas of the traction battery pack 18 can facilitate meeting power demands for various types of vehicles while maintaining substantially the same packaging footprint for the traction battery pack 18. Battery cells 38 can be omitted if not necessary to meet power demands for the electrified vehicle 10.

The cross-member assemblies 42 of the example traction battery pack 18 each have a longitudinal length L1. The groups 68 of battery cells 38 in the battery arrays 22B that lack the depopulated area 62 each have a longitudinal length L2. The group 58 of battery cells 38 within the battery array 22A has a longitudinal length L3 that is less than both the length L1 and the length L2.

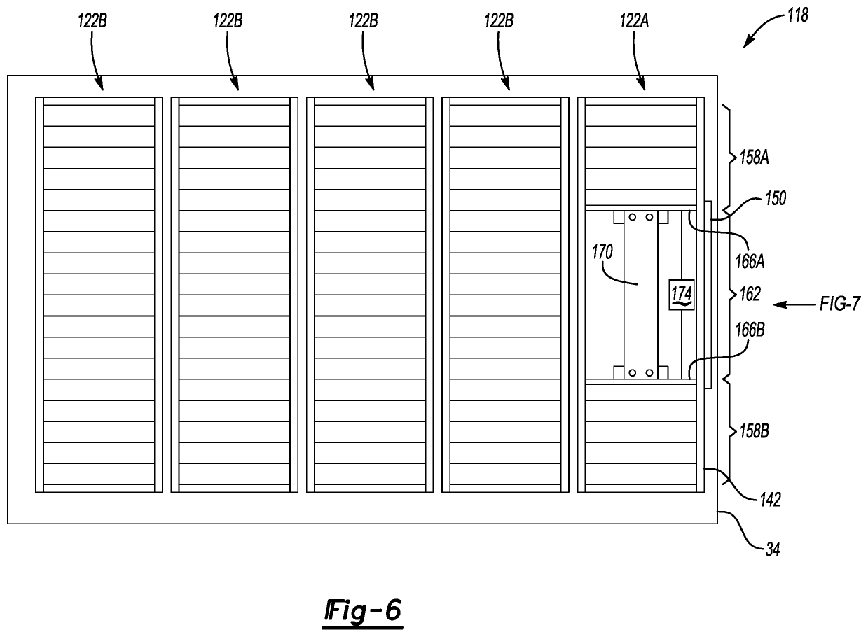

With reference now to the schematic view of FIG. 6, a battery pack 118 according to another exemplary embodiment, includes a battery array 122A having a first group 158A of battery cells 38 and a second group 158B of battery cells 38 that are spaced a distance from each other along an axis of the battery array 122A to provide an depopulated area 162.

The remaining battery arrays 122B of the battery pack 118 have a longitudinal length that is longer than a longitudinal length of the first group 158A or a longitudinal length of the second group 158B. The remaining battery arrays 122B include battery cells 38 that are placed adjacent to each other without any depopulated area between battery cells 38.

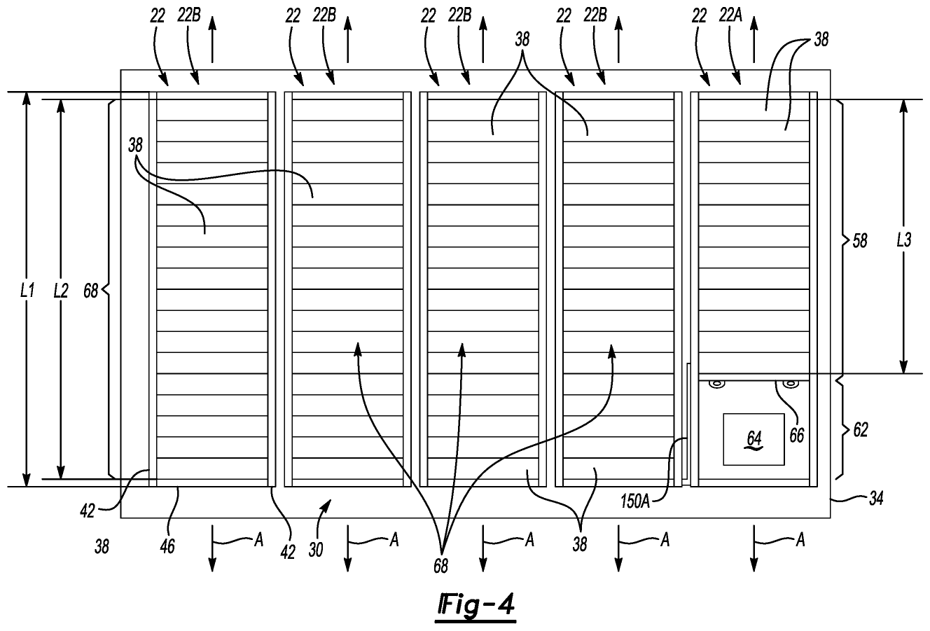

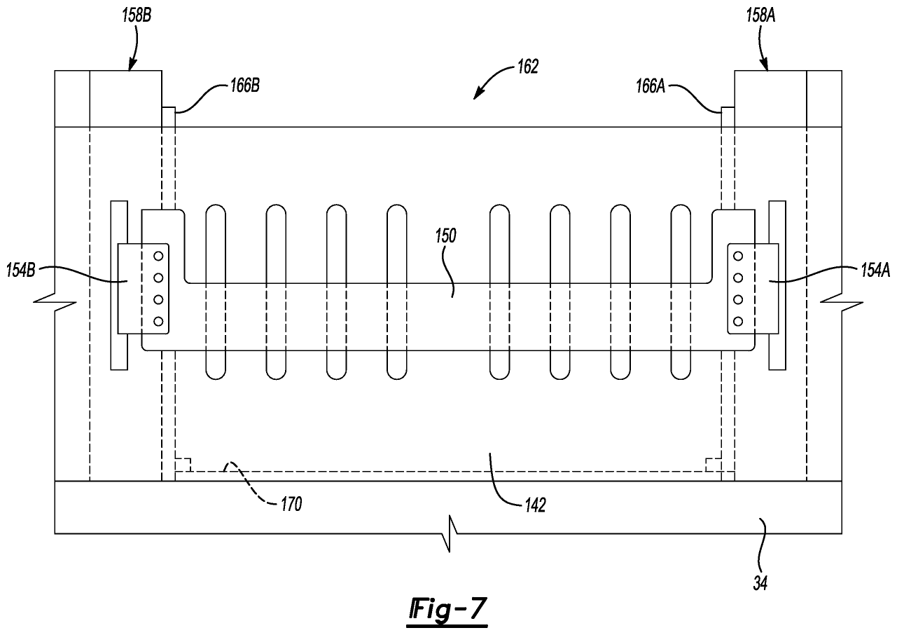

At least one of the cross-member assemblies 142 that is adjacent to the battery array 122A can include a busbar 150 that spans from the first group 158A to the second group 158B to electrically connect together the first group 158A and the second group 158B (FIG. 7). The busbar 150 can be directly connected to a tab terminal 154A of one or more battery cells 38 in the first group 158A and to the tab terminal 154B of one or more battery cells 38 in the second group 158B. The tab terminals 154A and 154B can extend through respective apertures in the cross-member assembly 142. The busbar 150 spans the depopulated area to electrically connects first group 158A to the second group 158B within the array 122A. In another example, a busbar 150A (FIG. 4) can span a depopulated area to electrically connect the array 22A to another of the arrays 22B.

In FIGS. 6 and 7, a bracing plate 166A can be used to help support the battery cells 38 in the first group 158A, and a bracing plate 166B can be used to help support the battery cells 38 in the second group 158B. A spanner bracket 170 can be attached to the bracing plate 166A and the bracing plate 166B to hold the positions of the bracing plate 166A and the bracing plate 166B along the axis of the battery array 122. The spanner bracket 170 can maintain the depopulated area 162. Other brackets and braces could be added as required to maintain positioning. In some examples, particularly if the depopulated area 162 is used to house electronic components, the depopulated area 162 could be at least partially lined with electromagnet shielding material.

In some examples, the depopulated area 162 (or the depopulated area 62), can house a midpoint breaker 174, which can, as required, be transitioned to disrupt a circuit through the battery pack 118. Positioning the midpoint breaker 174 in the depopulated area 162 can facilitate access to the midpoint breaker 174.

While the depopulated areas 62 and 162 are shown in the battery arrays 22A and 122A, the depopulated areas 62 and 162 could instead or additionally be incorporated into other battery arrays 22B and 122B. Further, while the depopulated areas 62 and 162 are shown in battery arrays residing on a single tier. Other battery packs could have multiple tiers of battery arrays, and depopulated areas could be in the battery arrays of an upper tier, the battery arrays of a lower tier, or both.

Features of this disclosure include omitting battery cells from one or more battery arrays of a battery pack to, among other things, facilitate fine-tuning the battery pack and its energy delivery capability for particular vehicles while maintaining a general battery pack architecture than can be replicated across different vehicle types. Selected battery cells, such as a parallel group of battery cells, can be removed from one or more arrays in a battery pack. Only changes to busbars of the cross-members may be needed to accommodate remove of those battery cells.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack assembly, comprising:
a cross-member assembly extending along a cross-member axis; and
a battery array alongside the cross-member assembly, the battery array having at least one group of battery cells and an depopulated area disposed along a battery array axis.

2. The battery pack assembly of claim 1, wherein the at least one group of battery cells includes a first group spaced a distance along the battery array axis from a second group to provide the depopulated area.

3. The battery pack assembly of claim 2, wherein the cross-member assembly includes a busbar spanning from the first group to the second group.

4. The battery pack assembly of claim 3, wherein the busbar is directly connected to a tab terminal of a battery cell in the first group and to a tab terminal of a battery cell in the second group.

5. The battery pack assembly of claim 1, wherein the battery array is a first battery array and the cross-member assembly is a first cross-member assembly, and further comprising a second battery array and a second cross-member assembly alongside the second cross-member assembly, the second battery array including a plurality of battery cells disposed along a second battery array axis without any depopulated area between the plurality of battery cells of the second battery array.

6. The battery pack assembly of claim 1, wherein the at least one group of battery cells is at least one group of pouch-style battery cells.

7. The battery pack assembly of claim 1, wherein an axial length of the battery array is nominally equal to an axial length of the cross-member assembly.

8. The battery pack assembly of claim 1, wherein the cross-member assembly includes a plurality of busbars, wherein tab terminals of the at least one group of battery cells extend through a respective aperture in the cross-member assembly to connect to at least one of the busbars within the plurality of busbars.

9. The battery pack assembly of claim 1, further comprising a battery pack component that is not a battery cell disposed within the depopulated area.

10. A battery pack assembly, comprising:
a cross-member assembly within a battery pack;
a first battery array on a first side of the cross-member assembly, the first battery array having a first number of battery cells; and
a second battery array on an opposite, second side of the cross-member assembly, the second battery array having a second number of battery cells that is different than the first number of battery cells.

11. The battery pack assembly of claim 10, wherein the first battery array has a first axial length and the second battery array has a second axial length that is different than the first axial length.

12. The battery pack assembly of claim 10, wherein the cross-member assembly is within a battery pack enclosure.

13. The battery pack assembly of claim 10, wherein the cross-member assembly extends in a cross-vehicle direction.

14. The battery pack assembly of claim 10, wherein the second battery array includes a first group of battery cells and a second group of battery cells that is spaced from the first group of battery cells to provide an depopulated area.

15. A battery pack battery cell positioning method, comprising:
placing a first battery array within an enclosure, the first battery array having at least one first cross-member assembly spanning between endplates of the first battery array and at least one first group of battery cells between the endplates of the first battery array; and
placing a second battery array within the enclosure, the second battery array having at least one second cross-member spanning between endplates of the second battery array at least one second group of battery cells between the endplates of the second battery array, a number of battery cells in the second group of battery cells less than a number of battery cells in the first group of battery cells to provide an depopulated area between the endplates of the second battery array.

16. The battery pack battery cell positioning method of claim 15, wherein the first group of battery cells has a first axial length and the second group of battery cells has a second axial length that is different than the first axial length.

17. The battery pack battery cell positioning method of claim 15, wherein the at least one second group of battery cells includes at least two second groups of battery cells spaced apart from each other to provide the depopulated area.

18. The battery pack battery cell positioning method of claim 15, further comprising a battery pack component that is not a battery cell disposed within the depopulated area.

19. The battery pack battery cell positioning method of claim 15, wherein a length of the at least one first cross-member is the same as a length of the at least one second cross-member.
